(19) United States
(12) Patent Application Publication
(10) Pub. No.: US 2015/0321891 A1
(43) Pub. Date: Nov. 12, 2015

(54) SCISSORS LIFTING TABLE AND METHOD OF ASSEMBLING A SCISSORS LIFTING TABLE

(71) Applicant: Christoph Mohr, Bielefeld (DE)

(72) Inventor: Christoph Mohr, Bielefeld (DE)

(21) Appl. No.: 14/411,220

(22) PCT Filed: May 28, 2013
(86) PCT No.: PCT/EP2013/001570

§ 371 Date: Dec. 24, 2014

(30) Foreign Application Priority Data
Jun. 29, 2012 (DE) 10 2012 012 934.3

(51) Int. Cl. B66F 7/06; B66F 7/28

(52) U.S. Cl. CPC B66F 7/065; B66F 7/28

(57) ABSTRACT

A scissors lift comprises an upper frame module (1) and a lower frame module (2), a scissor mechanism (3) and a drive unit (4). The upper frame module (1) and the lower frame module (2) are connected by the scissor mechanism (3) in such a way that a lifting movement, by which the spacing between the upper frame module (1) and lower frame module (2) changes, is rendered possible. The scissors lift, particularly the upper frame module (1) and/or the lower frame module (2), have a central portion (5) to which extension 6 and/or 7 that are pre-produced in fixed sizes and are fitted together in the manner of a modular construction system to make a scissors lifting lift of desired size.

### TECHNICAL FIELD

The invention relates to a scissors lifting table and to a method of assembling a scissors lifting table.

### BACKGROUND INFORMATION

Scissors lifting tables of the type under discussion have an upper and a lower frame module that are connected by scissors in such a manner that a lifting movement is made possible by which the distance between the upper and the lower frame module changes. In order to make possible the carrying out of the movement, the scissors lifting tables furthermore comprise a drive unit.

As a rule the scissors consist of two pairs of crossed scissor blades that are connected to one another in pairs by a middle support and are connected to one another at a distance by struts running in the direction of the width of the scissors lifting table. The struts running in the direction of width connect the inner and the other scissor blades to each other.

The inner or outer scissor blades are articulated to one of the frame modules in the area of the ends of the scissor blades. The ends of the scissor blades opposite the ends articulated to a frame module run on a guide rail or wear rail or in a guide in the particular other frame module in its longitudinal direction (the longitudinal direction of the lifting table), so that a relative rotary or pivoting movement of the inner scissor blades relative to the outer scissor blades can result in a spreading open of the scissors that that results in a changing of the distance of the frame modules by the cooperation of the articulation of the scissor blades to the frame modules with the possibility of sliding or rolling in the guides in the longitudinal direction, wherein the frame modules retain their parallel alignment to one another, i.e., the desired lifting movement is produced.

Such scissors lifting tables are used, for example, in assembly lines for the controlled raising of loads, for example, in the manufacture of automobiles, ergonomic workplace design, level bridging, in freight elevators and the like.

According to the prior art such scissors lifting tables are produced individually according to the requirement of the customer. The reason for this is that the scissors lifting table must meet precise specifications of the customer in its typical usages, in particular, for example, as part of an assembly line in order to fit into the particular assembly line or the particular production process. As a rule, other factors take precedence in the design of the assembly line over the dimensions of available lifting tables, i.e., the lifting table must be adapted to the assembly line or the process and not vice versa.

This has the result that the main elements of such a lifting table, in particular the upper and the lower frame module—also called the upper frame and the lower frame—as well as the scissors must be individually dimensioned and manufactured, which is associated, in addition to great expense, in particular with long delivery times.

### SUMMARY OF THE INVENTION

The invention therefore has the basic task of indicating or providing a scissors lifting table and a method of assembling a scissors lifting table that make it possible to construct economical scissors lifting tables in accordance with individual customer specifications, wherein in particular a significant shortening of the manufacturing time and therefore of the delivery times should be achieved.

The task is solved in accordance with the invention in that the scissors lifting table comprises prefabricated parts assembled in the manner of a modular system in fixed sizes. The selection of the parts, that are prefabricated in fixed sizes, advantageously comprises in particular the scissor blades and prefabricated base frame modules that form the part of the frame modules to be connected by the articulations and guides to the scissors. It is especially advantageous if the base frame modules can be used for the upper as well as for the lower frame module, i.e., identical base frame modules are used for the upper and the lower frame module.

It was previously assumed that due to the great number of different customer specifications the storing of parts prefabricated in fixed sizes was not worthwhile for such lifting tables since too great a number of differently sized components has to be stored, which entails for the one part the association of high expenses as investment for the parts to be prefabricated and on the other hand also entails a high storage place requirement and the associated expenses. However, a careful analysis of the specifications of scissors lifting tables delivered in the past surprisingly showed that it is basically possible to meet most of the customer specifications occurring in practice with scissors lifting tables that can be assembled from a relatively manageable number of prefabricated parts.

Therefore, the method of the invention for assembling a scissors lifting table provides that the parts to be used for the assembly are selected from a number of prefabricated parts in different given fixed sizes and/or designs depending on the specification of the scissors lifting table to be assembled, and the scissors lifting table is assembled from these parts. As a result, all manufacturing steps, aside from the final assembly or the possibly necessary manufacturing of special parts necessary in the individual case can be shifted into the prefabrication. A series manufacture instead of an individual manufacture is therefore possible in the prefabrication, which can be designed to be significantly more economical. Due to the fact that after the ordering by the customer only the final mounting or the assembling of the scissors from prefabricated parts has to take place, the realizable delivery times are significantly shortened.

Other advantages are achieved in the area of maintenance and the supply of replacement parts since even here, parts to not have to be manufactured first but can be taken from the storeroom and the search for errors and also any necessary instruction from assemblers is simplified by the construction of the lifting tables, which is in principle always the same or at least similar, which is in particular advantageous if the site of the use of a scissors lifting table due for maintenance or repair is located at a great spatial distance from the manufacturer and therefore any instructions from an installer on site are facilitated, are more economical or made possible in comparison to a trip having to be made. Also, the amount of replacement parts can be greatly reduced for the customers, who often use several different lifting tables, which also lowers the expenses.

The ability to realize the invention is advantageously favored by a number of constructive measures of the scissors lifting table. Thus, the base frame modules advantageously have fastening elements in the area of their front sides which elements can be flanges for screws. In addition to the screws, even other connection techniques are basically possible such as welding, adhering, suspension and the like.

Extension modules are advantageously fastened on these fastening elements so that the extension modules form, as extension of the base frame modules, a part of the frame module. This usage of extension modules makes possible the ability to rapidly make frame modules available in different lengths. Even a plurality of extension modules can be fastened in succession on the same front side of a base frame module, for example, in order to realize the greatest possible number of lengths of a frame modules to be produced with the greatest limited number of extension modules to be prefabricated in different lengths by assembling extension modules of different lengths.

The scissors lifting table advantageously comprises a drive module in which the drive unit, that is, the actual drive, i.e., a motor, a winding shaft, a hydraulic drive, a spindle drive or the like is received, wherein the drive module also forms a part of the frame module as an extension of the base frame module. The drive element is advantageously fastened on the lower base frame module. In this manner it is possible, by storing different embodiments of drive modules provided, for example, with different types of drive units, to realize a plurality of different scissors lifting tables in that a base frame module is combined, depending on the specifications concerning the properties of the base frame module, that is, in particular, width and lift, with the drive module equipped with a drive unit that corresponds to the customer specifications.

During the assembly of the scissors the use of the same parts can also be advantageously optimized if identical scissor blades are used as the inner and outer scissor blades for the construction of the particular right and left scissors packet. This makes it possible to keep prefabricated inner and outer scissor blades available in fixed sizes and designs. The inner and outer scissor blades selected from the stored scissor blades are then connected to each other by a central support, wherein the relative position of the inner scissor blade and the outer scissor blade to one another results by the disposition of the scissor blades during the connection to the central support, and therefore the use of the scissors packet produced is set as a left or a right scissors packet of the scissors of the lifting table. The two scissors packets are then assembled by struts in the direction of width, wherein the struts in the direction of width sets the width of the scissors, that depends on the width of the desired lifting table to be assembled. Here too, a plurality of lifting table variants with relatively few identical parts can be realized by the combination of different struts in the direction of width for different widths and different scissor blades, in particular for realizing different lifts. The connection of the struts in the direction of width to the scissor blades can be advantageously realized here by screws that can be rapidly mounted and also detached again for maintenance or replacement but also in a conventional manner by welded connections. The central supports are advantageously also fixed in the scissor blades by screws.

### BRIEF DESCRIPTION OF THE DRAWINGS

These and other features and advantages of the present invention will be better understood by reading the following detailed description, taken together with the drawings wherein:

FIG. 1—is a schematic view of a section of an exemplary scissors lifting table in accordance with the invention;

FIG. 2—is a schematic view of an exemplary scissors mechanism for a scissors lifting table in accordance with the invention; and

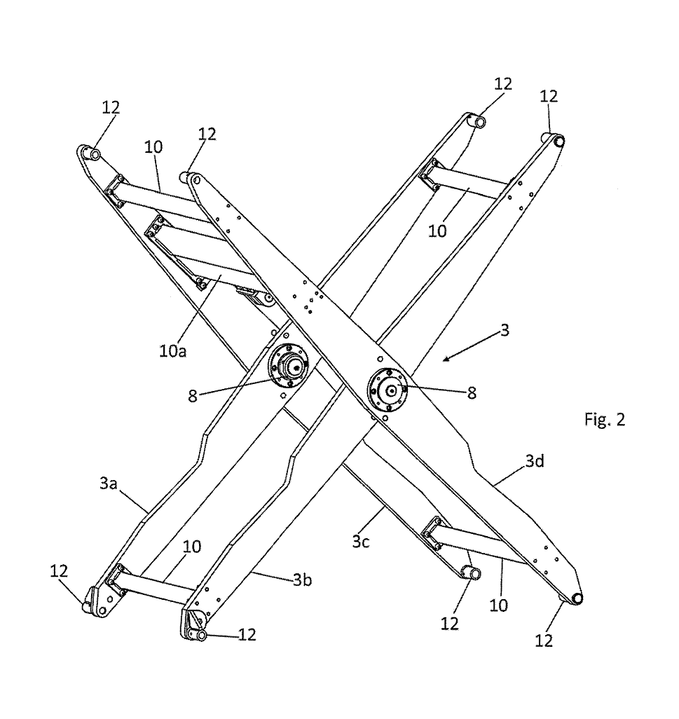

FIG. 3—is a schematic view if an exemplary scissors packet for a scissors lifting table in accordance with the invention.

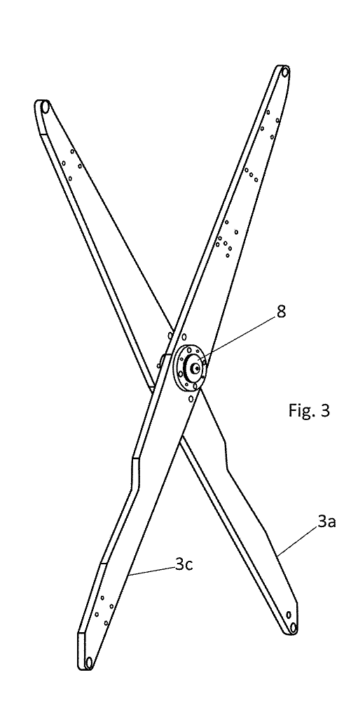

### DETAILED DESCRIPTION OF THE PREFERRED EMBODIMENTS

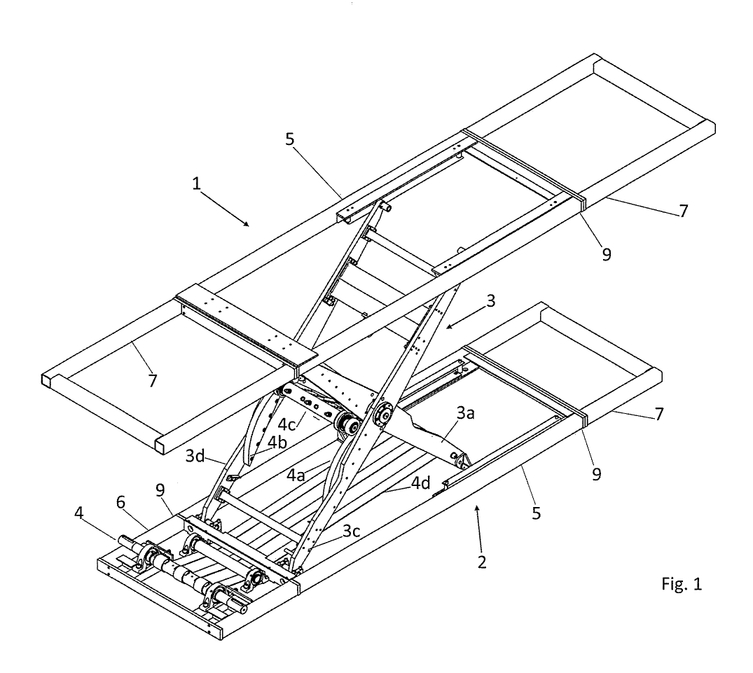

The exemplary scissors lifting table in accordance with the invention comprises an upper frame module 1, FIG. 1, and a lower frame module 2 connected by the scissors assembly 3. A central frame module 5 is a component of both the upper frame module 1 and of the lower frame module 2. Other components of the upper frame module 1 and of the lower frame module 2 are extension modules 7 fastened to one or more sides of the central frame module 5 in order to allow the upper and/or lower frame modules 1, 2 to be provided at a customer specific length. To this end, the extension modules 7 are fastened to the central frame modules 5 utilizing fastening elements 9, in the example shown in the form of flanges and screws (not shown for the sake of clarity).

The drive unit 4 is received or located on a drive module 6 that is connected like the extension modules 7 by a fastening element 9 to a central frame module 5 on one side side.

In the exemplary embodiment shown, the scissors assembly 3 comprise mounted parts 4a and 4b in the form of guides for a movable element 4c of the drive which element is moved by the drive unit 4 via a deflected belt 4d and therefore brings about the lifting and lowering movement of the scissors lifting table 1.

The scissors mechanism 3 comprise two identical inner scissor blades 3a and 3b and two identical outer scissor blades 3c and 3d, and wherein an inner and an outer scissor blade are pivotably connected together by a central support 8 to form a scissors packet. In these scissors packets formed by central support 8 and two scissor blades, the side of the lifting table on which the scissors packet is to be used is fixed by the connection of the scissor blades to the central support 8. Therefore, a right scissors packet 3a, 3c and a left scissors packet 3b, 3d are produced that are combined or held together in relative position by struts 10 in the direction of the width of the lifting table.

In the example shown, the struts 10 are screwed to the scissor blades 3a, 3b, 3c and 3d. In addition to the struts 10, that serve only to ensure the structural stability of the scissors assembly 3 and scissors table 1, multifunctional struts 10a are also possible that, for example, constitute the support for a deflection device of the drive of the lifting table. The scissor blades 3a, 3b, 3c and 3d also include elements 12 that serve to articulate and guide the scissors 3 on the central frame modules 5 of the upper and lower frames 1, 2 respectively. The latter are designed in such a manner that they can be mounted on both sides of the scissor blades, so that the ability to use the particular inner or outer scissor blade on both sides as such, i.e., without mounted elements is ensured.

An exemplary method of the invention for the assembly of a lifting table can be as follows:

Six different scissors, for example, in two widths and three different scissor blade lengths and, corresponding to the above, six different sizes of central frame modules 5 are prefabricated and furthermore, ten extension modules 7 in different sizes and drive modules 6 in two sizes, each with three different drives units 4 are made available. In addition, two different types of scissors central supports are stored, for example, one designed as a plain bearing and one as an articulation support. Approximately 450 different scissors lifting tables can already be realized with these parts. If the dimensions and designs of the individual parts are skillfully selected based on the experiences from lifting tables produced in the past, then most of the scissors lifting tables demanded in practice that otherwise would have to be individually manufactured according to customers' wishes can be made available in a very short time in this manner with a small number of different parts to be stored.

Modifications and substitutions by one of ordinary skill in the art are considered to be within the scope of the present invention, which is not to be limited except by the allowed claims and their legal equivalents.

1. A scissors lifting table, comprising an upper frame module (1) and a lower frame module (2), a scissors mechanism (3) and a drive unit (4), wherein the lower frame module (1) and the upper frame module (2) are connected by the scissors mechanism (3) in such a manner that the achieving of a lifting movement by which a distance from the upper frame module (1) and the lower frame module (2) changes is made possible, characterized in that the upper and lower frame modules (1, 2) each include an identical central frame module (5), wherein one or more of the central frame modules (5) of one or more of the upper and lower frame modules (1, 2) are coupled to an extension module (7), wherein the extension module (7) forms a part of the frame module (1, 2) as an extension of the central frame module (5), and wherein one of the frame modules (1, 2), preferably the lower frame module (2), is coupled to a drive module (6) on which the drive unit (4) is disposed, wherein the drive module (6) forms a part of the frame module (1, 2) as an extension of the central frame module (5) of the one frame module to which the drive module (6) is coupled, and wherein the extension modules (7) and the drive module (6) are coupled to their respective upper and/or lower frames (1, 2) by means of fastening elements (9).

2. (canceled)

3. (canceled)

4. The scissors lifting table according to claim 1, characterized in that the scissors mechanism (3) comprises an inner left scissor blade (3a) and an inner right scissor blade (3b), and wherein the inner left scissor blade (3a) and the inner right scissor blade (3b) are identical.

5. The scissors lifting table according to claim 4, characterized in that the scissors mechanism (3) comprises an outer left scissor blade (3c) and an outer right scissor blade (3d), and wherein the outer left scissor blade (3c) and the outer right scissor blade (3d) are identical.

6. (canceled)

7. (canceled)

8. The scissors lifting table according to claim 1, characterized in that the inner and the outer right and left scissor blades (3a, 3b, 3c, 3d) are connected by a central support (8) to a right and/or left scissors packet, wherein the construction of the scissors packet as a left or a right scissors packet is fixed by the fixing of the central support (8) in the scissor blades by plurality of screws.

9. (canceled)

10. (canceled)

11. The scissors lifting table according to claim 1, characterized in that the
drive module (6) and one or more extension module (s) (7) are selected from a group of prefabricated drive modules (6) and extension modules (7) of different given fixed sizes and/or designs.

12. The scissors lifting table according to claim 5, characterized in that the
two identical inner scissor blades (3a, 3b) and two identical outer scissor blades (3c, 3d) to be used for the scissor mechanism (3) from a group of prefabricated scissor blades (3a, 3b, 3c, 3d) of different given fixed sizes and/or designs.

13. A scissors lifting table, comprising an upper frame module (1) and a lower frame module (2), a scissors mechanism (3) and a drive unit (4), wherein the lower frame module (1) and the upper frame module (2) are connected by the scissors mechanism (3) in such a manner that the achieving of a lifting movement by which a distance from the upper frame module (1) and the lower frame module (2) changes is made possible, characterized in that the upper and lower frame modules (1, 2) each include an identical central frame module (5), wherein one or more of the central frame modules (5) of one or more of the upper and lower frame modules (1, 2) are coupled to an extension module (7), wherein the extension module (7) forms a part of the frame module (1, 2) as an extension of the central frame module (5), and wherein one of the frame modules (1, 2), preferably the lower frame module (2), is coupled to a drive module (6) on which the drive unit (4) is disposed, wherein the drive module (6) forms a part of the frame module (1, 2) as an extension of the central frame module (5) of the one frame module to which the drive module (6) is coupled, and wherein the extension modules (7) and the drive module (6) are coupled to their respective upper and/or lower frames (1, 2) by means of fastening elements (9);
wherein the scissors mechanism (3) comprises an inner left scissor blade (3a) and an inner right scissor blade (3b), and wherein the inner left scissor blade (3a) and the inner right scissor blade (3b) are identical in shape and size; and
wherein the scissors mechanism (3) comprises an outer left scissor blade (3c) and an outer right scissor blade (3d), and wherein the outer left scissor blade (3c) and the outer right scissor blade (3d) are identical in shape and size.
